(19) United States
(12) Patent Application Publication
(10) Pub. No.: US 2007/0172602 A1
(43) Pub. Date: Jul. 26, 2007

(54) Method of forming a plasma and use for decontamination by decomposition of toxic substances

(75) Inventor: Francois Reniers, Brussels (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/587,453

(22) PCT Filed: Jan. 26, 2005
(86) PCT No.: PCT/EP05/50329

§ 371 Date: Jan. 30, 2007

(30) Foreign Application Priority Data
Jan. 29, 2004 (FR) 04.00981

(51) Int. Cl. H05H 1/24

(52) U.S. Cl. 427/569

(57) ABSTRACT

Method of forming a plasma intended for the chemical treatment of substances, in which at least two electrodes and a layer of dielectric material located between the two electrodes are placed in a chamber in order to form plasma glow discharges, in which a controlled flow comprising oxygen is introduced into the chamber, the controlled flow of gas during its introduction into the chamber containing none of the substances to be treated.

The invention lies within the field of plasma chemistry. It relates to a method of forming a plasma intended for the chemical treatment of substances. It also relates to the use of plasmas for decontamination by decomposition of toxic substances, in particular organochlorines.

Field of plasma chemistry deals with chemical reactions taking place in an ionized gas, consisting of ions, energetic electrons and neutral species. A plasma is electrically neutral, i.e. the number of electrons must balance the number of positive ions. This balance is dynamic—the positive ions recombining with the energetic electrons without cease, to be then ionized again. Owing to this dynamic situation and the many collisions that it generates, a plasma contains many chemically highly active radicals and is therefore the site of intense chemical reactions.

Two types of plasma are of most interest in chemistry, that called an are plasma and that called a glow discharge plasma. These plasmas are generated by electrical discharges between two electrodes. Are plasmas, in which the current flows entirely through a restricted volume, are in thermal equilibrium, which means that the electron, ion and neutral species (comprising the carrier gas, radical and metastable species) temperatures are practically identical. In contrast, glow discharges, in which the current is distributed more homogeneously in the space defined between the electrodes, are not in thermal equilibrium, the neutral species temperature (e.g. 300-500 K) being substantially below the electron temperature (e.g. 10 000 K). The appearance of such discharges is favoured by the presence, in the plasma torch, of a dielectric between the electrodes. They are consequently sometimes called dielectric barrier discharges. Because of their macroscopic homogeneity and the richness of the chemical reactions occurring therein, glow discharges are used for various chemical treatments, such as the activation of surfaces or the destruction of pollutants.

Many methods of forming such plasmas have already been studied.

Thus, document WO 03/005397 discloses a dielectric plasma emitter allowing easy chemical treatment of surfaces.

However, this known emitter does not allow powerful chemical treatments to be carried out, such as those needed in the field of decontamination by decomposition of highly toxic and chemically stable substances, such as organochlorines.

It is an object of the invention to provide an improved method of forming a dielectric plasma for carrying out powerful and reproducible chemical treatments.

Consequently, the invention relates to a method of forming a plasma intended for the chemical treatment of substances, in which two electrodes and a layer of dielectric material located between the two electrodes are placed in a chamber in order to form plasma glow discharges, the method being characterized in that a controlled flow comprising oxygen is introduced into the chamber, the controlled flow during its introduction into the chamber containing none of the substances to be treated.

To obtain a glow discharge, the electrodes must be subjected to a potential difference of sufficient magnitude and of sufficient frequency, these being in particular dependent on the nature of the carrier gas, i.e. the gas in which the discharge is initiated, and on the pressure of the latter. If the frequency is not high enough, the discharge is unstable and, even if it is of the glow type at its inception, evolves towards an arc type discharge. Among the many possible carrier gases (e.g. helium, argon, nitrogen and oxygen), helium makes it possible to obtain discharges that are stable at relatively low frequencies, close to 10 kHz. Since one of the electrodes (the “cold” electrode) is earthed, the other electrode (the “hot” electrode) is raised to a potential that exceeds the breakdown potential. By way of an example, for helium at atmospheric pressure, plane electrodes separated by an interelectrode distance of 5 mm and a frequency of 10 kHz, this potential is about 2000 Vrms. It is important to obtain a current density (current per unit area) of sufficient value in the discharge. Values of greater than 0.1 mA/cm², preferably 0.5 mA/cm², are recommended. In the event of prolonged operation, it is advantageous to provide the hot electrode with a cooling device, for example in which a temperature-conditioned fluid circulates.

According to the invention, the method comprises the introduction of a controlled flow comprising oxygen into the chamber, the controlled flow during its introduction into the chamber containing none of the substances to be treated. It is recommended that the flow be at least partly in gaseous form. Preferably, it is entirely gaseous.

The paramount role played by oxygen in chemistry is well known. In the field of plasma chemistry, oxygen, whether ionized or in radical form, possesses an increased reactivity in a plasma and consequently plays an even more pronounced role. Unfortunately, the presence of oxygen can destabilize the plasma and very rapidly cause it to change towards a macroscopically inhomogeneous discharge. This is particularly the case when the plasma discharge is intended to make a substance undergo a chemical reaction in the gaseous state and when this substance is mixed with oxygen before its introduction into the plasma chamber. The inventors have observed that when oxygen is introduced separately, in a strictly controlled and very constant amount, there are means of stabilizing plasmas containing large amounts of oxygen. The oxygen contained in the flow is advantageously in a proportion of between 1% and 100%, preferably between 2% and 100%, by weight. Amounts of at least 5% are especially preferred It is particularly recommended for the proportion to be at least 10%. The oxygen contained in the flow may be in the form of O₂. It may be completely or partly in another chemical form, such as for example water. Preferably, it is at least partly in the form of O₂.

The plasma obtained under these conditions remains a glow plasma through the discharge, that is to say the discharge fills essentially the volume bounded by the electrodes and the plasma remains cold, not in thermal equilibrium. However, with high oxygen contents, of greater than 1%, the glow discharge becomes filamentary. Close observation of the plasma shows that the glow discharge consists of a large number of filaments extending between the electrodes. In such a plasma, which is particularly suitable for the chemical treatment of substances, the electrical energy consumed by the discharge is used mainly to produce active oxygen radicals and not to produce heat. Such a plasma also allows heat-sensitive substances to be chemically treated.

In the method according to the invention, it is possible and recommended that the plasma pressure is near atmospheric pressure, that is between 0,9 preferably 0,95 bar and 1,1 preferably 1,05 bar. It is advantageous that the plasma is at the local atmospheric pressure.

The electrodes may have a very large variety of relative shapes and arrangements. For example, they may be plane, with their large sides facing each other.

In a preferred embodiment of the method according to the invention, the electrodes are of concentric cylindrical geometry. The inner electrode may then very simply be a wire located at the centre of the outer electrode. The outer electrode may be a simple ring surrounding the wire or it may constitute all or part of the chamber. In this embodiment, the flow rate of the controlled oxygen flow may be adjusted so as to expel some of the active substances of the plasma out of the chamber in order to obtain, at the open end of the cylinders, a plasma overflow, allowing easy chemical treatment of substances in high volume, in particular in the solid state.

The layer of dielectric material stabilizes the plasma. The material comprising the dielectric appears to play an important role in the effectiveness of the chemical treatment brought about by the plasma. Glass (Pyrex) or alumina give good results. Alumina is preferred. Moreover, the layer of dielectric material that has to be located between the two electrodes is advantageously in contact with one of them, for example in the form of a coating.

In a preferred variant of the method according to the invention, at least one of the electrodes is covered with a dielectric layer comprising alumina. It is recommended that the surface of the dielectric layer be very smooth. Average roughness of less than one micron, preferably less than 0.2 μm, are preferred In this variant, when the electrodes are in a horizontal position, it appears that the substances to be chemically treated, in particular organochlorine substances, may be placed directly in contact with the electrode covered with the dielectric layer and that they are easily distributed uniformly thereon. This improves the effectiveness of the treatment in a very simple manner.

Thanks in particular to the controlled oxygen flow, the method according to the invention forms a plasma that is especially well suited to decontamination by decomposition of toxic substances that are chemically stable and therefore difficult to decompose.

Consequently, the invention also relates to the use of the plasma obtained by the method according to claims 1 to 3 for decomposing toxic substances.

Among the toxic substances that the plasma obtained by the method according to the invention can decompose particularly effectively, mention may be made of hydrocarbons of the heavy oil type, especially crude oil, organofluorine molecules and organochlorine molecules. It is known that certain toxic organochlorine compounds have a long half life of the order of tens of years in the ground, and thus are highly damaging to the environment. These compounds, which are hydrophobic, avoid aqueous phases and are concentrated in fatty tissues. They accumulate in the food chain and are dangerous to humans.

In an advantageous variant of the use according to the invention, the plasma obtained by the method according to the invention proves to be capable of decomposing toxic organochlorine substances. As examples of such substances, mention may be made of hexachlorobenzene and hexachlorobutadiene. This method constitutes an economically advantageous replacement of the known, and very expensive, decontamination techniques such as incineration or ultraviolet treatment.

The toxic substances treated according to the invention may be in the gaseous state. However, it is observed that the plasma is also effective for decomposing toxic substances in the liquid state and, in a preferred variant of the use according to the invention, even substances in the solid state. Without wishing to be tied down by one theoretical explanation, the inventors believe that the surprising effectiveness of the plasma obtained by the method according to the invention in decomposing substances in the solid state is due to the ability of this method to enrich the plasma with oxygen radicals. This preferred variant of the use according to the invention has the advantage that it is no longer necessary to vaporize the substance before it is decomposed. However, it is recommended that the solid substances to be decomposed be in the state of a fine powder, the mean powder particle diameter being for example less than 200 μm.

In one advantageous embodiment of the use according to the invention, the plasma includes water. The water may be employed using any suitable method. It may be deposited on the surface of the toxic substance to be decomposed or may be mixed therewith. In a preferred variant of this embodiment, the gas flow containing oxygen is bubbled in a controlled manner through water, thereby becoming charged with water vapour. In this embodiment, the effectiveness of the use according to the invention is increased.

During the decomposition of the toxic substances, CO₂ is formed. By confining the decomposition reaction and by collecting and measuring the CO₂ produced, there are means of applying the rules of stoichiometry to determine the amount of toxic substances decomposed. This measurement may for example be carried out by mass spectrometry.

The means employed in the present invention are intended for the chemical treatment of substances, particularly toxic substances. Some of these means are nevertheless capable of finding other applications.

Consequently, the invention also relates to a device for forming a plasma, comprising two electrodes located in a chamber, in order to form plasma glow discharges, and means for introducing a controlled flow of oxygen-containing gas into the chamber, the device being characterized in that at least one of the electrodes is covered with a dielectric layer comprising alumina.

Features and details of the invention will become apparent from the following description of the appended figures.

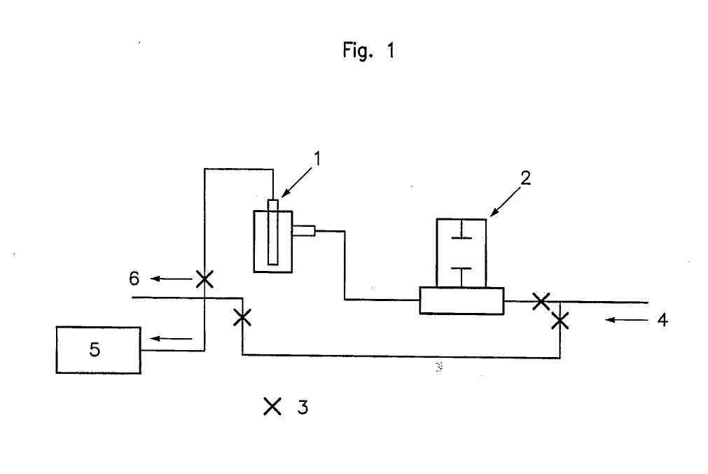

FIG. 1 is a diagram of certain elements of the installation, in the case of which the specimen of substance to be chemically treated is introduced manually into the plasma chamber. Shown in this figure is a trap (1) cooled by liquid nitrogen, the plasma chamber (2), valves (3), the inlet (4) for the oxygen-containing stream, with a direct shunt to the mass spectrometer (5), and an outlet (6) to atmosphere.

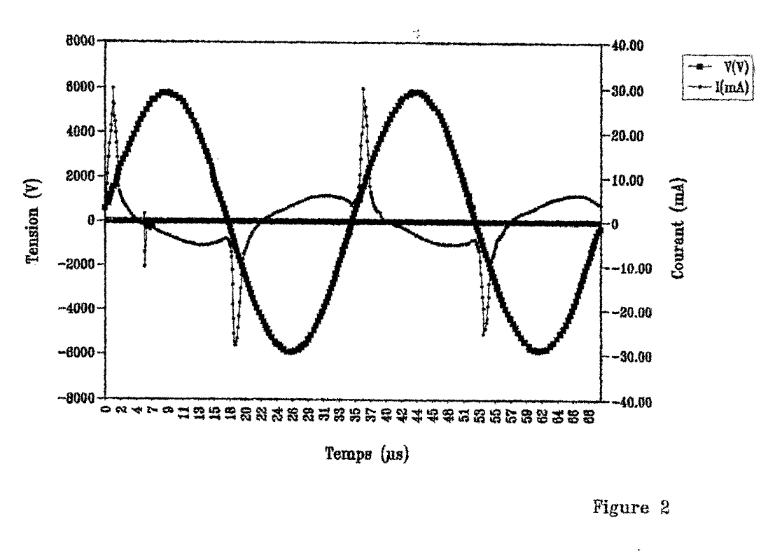

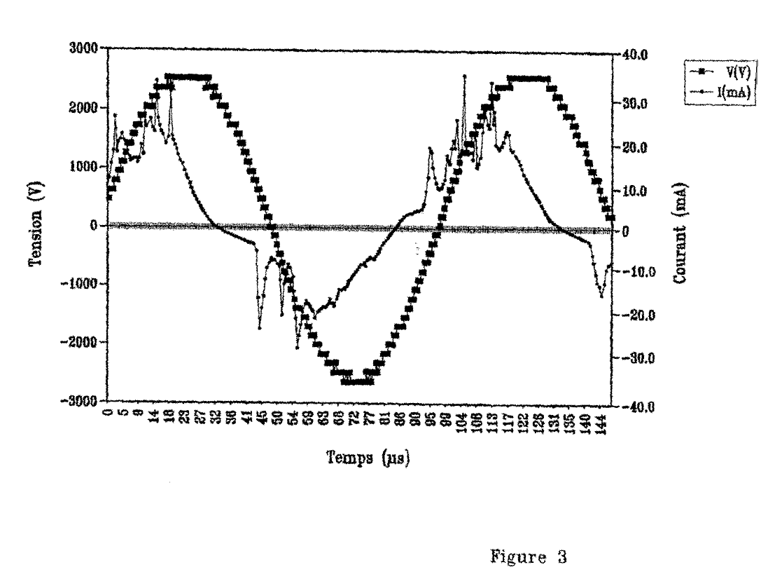

FIGS. 2 and 3 are oscillograms showing the glow discharge voltage and current as a function of time. In FIG. 2, the discharge is completely homogeneous, whereas in FIG. 3 it is filamentary.

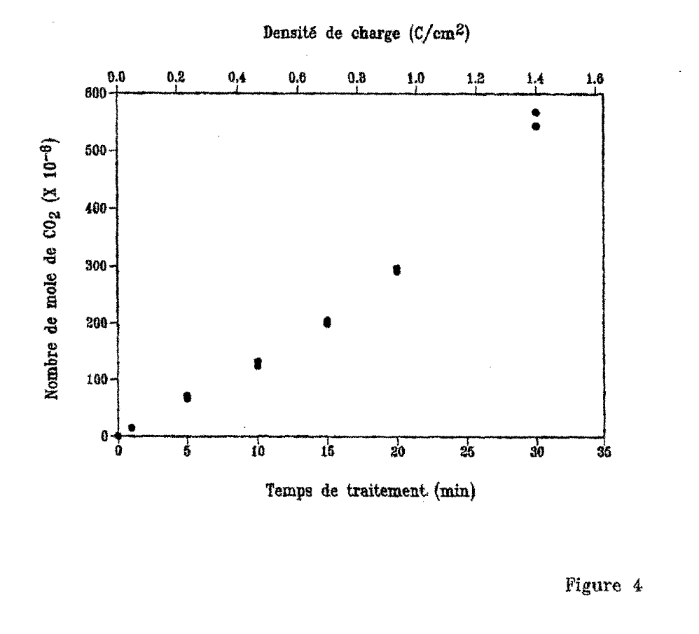

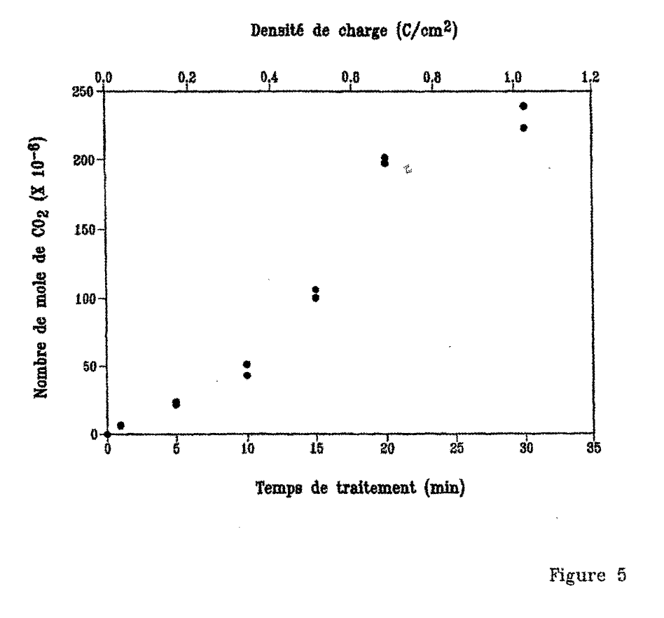

FIGS. 4 and 5 illustrate the production of CO₂ over time in the case of the decomposition according to the invention of hexadecane (FIG. 4) and hexachlorobenzene (FIG. 5).

The following examples illustrate the invention.

In these examples, the procedure is carried out in general in the following manner:
placing of the specimen against the “cold” electrode of the plasma, the area of the circular electrodes being 38.5 cm², the distance apart being 5 mm and the hot electrode being covered with a 1 mm layer of alumina;
pumping down to a pressure of 50 mbar
venting to atmospheric pressure with an He/O₂ gas mixture;
introducing a flow into the chamber, consisting of an He/O₂ (2.5 or 10%) mixture with a flow rate of 102 or 150 ml/min;
placing of a liquid nitrogen trap;
opening of the inlet valve of the mass spectrometer;
application of a plasma of defined power for a defined duration;
accumulation of the reaction products in the trap over the duration of the discharge;
removal of the trap, the latter being heated up to room temperature; and
acquisition of the spectrometer signal.

The examples are grouped together into four series of tests, the aim respectively being to illustrate the effects of:
the discharge current (first series of tests—Tables 1 and 2);
the treatment time (second series—Tables 3 and 4: FIGS. 4 and 5);
the amount of oxygen employed (third series, Table 5); and
the presence of water (fourth series of tests, Table 6) on the effectiveness of the decomposition of hexadecane and of hexachlorobenzene. This effectiveness was determined by measuring the quantity of CO₂ produced during the decomposition by mass spectrometry and converting this quantity into quantities of pollutants by stoichiometry (e.g. 1 mol of CO₂ produced corresponds to 1/16 mol of hexadecane, i.e. 226.45 g of equivalent mass decomposed.
   In the following tables, the electrical discharge conditions are determined by:
the charge density, obtained by integrating the current over the treatment time and by dividing this by the electrode area (38.5 cm²);
the energy density, which is the charge density multiplied by the rms voltage applied to the electrodes, divided by the mass of pollutant decomposed.

The amount of oxygen introduced into the plasma may be deduced directly by multiplying the gas flow rates (ml/min), the composition of the flow and the duration of the discharge.

First Series of Tests

In the first series of tests, 200 mg of hexadecane or hexachlorobenzene to which 2 ml of water had been added were subjected for 5 minutes to a glow plasma under a 102 ml/min gas flow composed of 98% He and 2% 02. The discharge current was varied. The results are given in Table 1 in the case of hexadecane and in Table 2 in the case of hexachlorobenzene.

TABLE 1
First series of tests - hexadecane
Effect of the discharge current on the production of CO₂

| | | | | Number | | | |
|---|---|---|---|---|---|---|---|
| | Discharge | | Charge | of mols | Degraded | Energy | Energy |
| Test | current | Voltage | density | of CO₂ | equivalent | density/mol | density/kg |
| No. | (mA) | (V) | (C/cm²) | (×10⁻⁶) | mass (mg) | (MJ/cm² · mol) | (kWh/cm² · kg) |
| 1 | 5 | 1650 | 3.90 × 10⁻² | 2.88 | 4.08 10⁻² | 357 | 438 |
| | | | | 3.18 | 4.50 10⁻² | 324 | 397 |
| 2 | 10 | 2180 | 7.79 × 10⁻² | 7.44 | 0.105 | 365 | 449 |
| | | | | 7.46 | 0.106 | 365 | 445 |
| 3 | 15 | 2620 | 0.117 | 20.1 | 0.284 | 244 | 299 |
| | | | | 20.5 | 0.290 | 239 | 293 |
| 4 | 20 | 2880 | 0.156 | 28.2 | 0.399 | 255 | 313 |
| | | | | 28.4 | 0.402 | 253 | 310 |
| 5 | 25 | 3200 | 0.195 | 42.9 | 0.607 | 233 | 285 |
| | | | | 43.7 | 0.618 | 228 | 280 |
| 6 | 27 | 3260 | 0.210 | 62.8 | 0.889 | 174 | 214 |
| | | | | 65.8 | 0.931 | 166 | 204 |
| 7 | 28 | 3300 | 0.218 | 63.2 | 0.894 | 182 | 223 |
| | | | | 65.8 | 0.931 | 175 | 214 |
| 8 | 30 | 3500 | 0.234 | 66.2 | 0.937 | 198 | 243 |
| | | | | 69.8 | 0.988 | 188 | 230 |

TABLE 2
First series of tests - hexachlorobenzene
Effect of the discharge current on the production of CO₂

| | | | | Number | | | |
|---|---|---|---|---|---|---|---|
| | Discharge | | Charge | of mols | Degraded | Energy | Energy |
| Test | current | Voltage | density | of CO₂ | equivalent | density/mol | density/kg |
| No. | (mA) | (V) | (C/cm²) | (×10⁻⁶) | mass (mg) | (MJ/cm² · mol) | (kWh/cm² · kg) |
| 15 | 5 | 2000 | 3.90 × 10⁻² | 1.42 | 6.74 × 10⁻² | 329 | 321 |
| | | | | 1.42 | 6.74 × 10⁻² | 329 | 321 |
| 16 | 10 | 2400 | 7.79 × 10⁻² | 1.31 | 6.22 × 10⁻² | 856 | 835 |
| | | | | 1.43 | 6.79 × 10⁻² | 784 | 765 |
| 17 | 15 | 2600 | 0.117 | 1.53 | 7.26 × 10⁻² | 1193 | 1164 |
| | | | | 1.55 | 7.36 × 10⁻² | 1177 | 1147 |
| 18 | 20 | 2874 | 0.156 | 1.98 | 9.40 × 10⁻² | 1359 | 1325 |
| | | | | 2.19 | 0.104 | 1228 | 1196 |
| 19 | 21 | 2900 | 0.164 | 7.21 | 0.342 | 396 | 386 |
| | | | | 7.45 | 0.354 | 383 | 373 |
| 20 | 22 | 3000 | 0.171 | 21.8 | 1.03 | 141 | 138 |
| | | | | 22.8 | 1.08 | 135 | 132 |

The first series of tests illustrates the importance of obtaining a sufficient arge current.

Second Series of Tests

In the second series of tests, 200 mg of hexadecane or hexachlorobenzene, which 2 ml of water had been added, were subjected to a glow plasma, under a current of 30 mA (HD) or 22 mA (HCBz) and a gas stream of 102 ml/min osed of 98% He and 2% O₂. The treatment time was varied. The results are given in Table 3 and in FIG. 4 in the case of hexadecane, and in Table 4 and FIG. 5 in the case of hexachlorobenzene (2 tests).

TABLE 3
Second series of tests - hexadecane
Effect of treatment time on the production of CO₂

| | | | | Number | | | |
|---|---|---|---|---|---|---|---|
| | Treatment | | Charge | of mols | Degraded | Energy | Energy |
| Test | time | Voltage | density | of CO₂ | equivalent | density/mol | density/kg |
| No. | (min) | (V) | (C/cm²) | (×10⁻⁶) | mass (mg) | (MJ/cm² · mol) | (kWh/cm² · kg) |
| 9 | 1 | 3500 | 4.67 × 10⁻² | 14.5 | 0.205 | 180 | 221 |
| | | | | 14.7 | 0.208 | 177 | 218 |
| 10 | 5 | 3500 | 0.234 | 66.2 | 0.937 | 198 | 243 |
| | | | | 69.8 | 0.988 | 188 | 230 |
| 11 | 10 | 3500 | 0.467 | 121 | 1.71 | 216 | 265 |
| | | | | 129 | 1.82 | 203 | 249 |
| 12 | 15 | 3800 | 0.701 | 196 | 2.77 | 217 | 267 |
| | | | | 200 | 2.83 | 213 | 261 |
| 13 | 20 | 3800 | 0.935 | 287 | 4.06 | 198 | 243 |
| | | | | 293 | 4.15 | 194 | 238 |
| 14 | 30 | 3800 | 1.40 | 539 | 7.63 | 158 | 194 |
| | | | | 563 | 7.97 | 151 | 185 |

TABLE 4
Second series of tests - hexachlorobenzene
Effect of treatment time on the production of CO₂

| | | | | Number | | | |
|---|---|---|---|---|---|---|---|
| | | | Charge | of mols | Degraded | Energy | Energy |
| Test | Treatment | Voltage | density | of CO₂ | equivalent | density/mol | density/kg |
| No. | time (min) | (V) | (C/cm²) | (×10⁻⁶) | mass (mg) | (MJ/cm² · mol) | (kWh/cm² · kg) |
| 21 | 1 | 3000 | 343 × 10⁻² | 6.72 | 0.319 | 91.9 | 89.6 |
| | | | | 6.78 | 0.322 | 91.1 | 88.8 |
| 22 | 5 | 3000 | 0.171 | 21.8 | 1.03 | 141 | 138 |
| | | | | 22.8 | 1.08 | 135 | 132 |
| 23 | 10 | 3000 | 0.343 | 42.6 | 2.02 | 145 | 141 |
| | | | | 51.00 | 2.42 | 121 | 118 |
| 24 | 15 | 3500 | 0.514 | 100 | 4.75 | 108 | 105 |
| | | | | 106 | 5.03 | 102 | 99.3 |
| 25 | 20 | 3500 | 0.686 | 197 | 9.35 | 73.1 | 71.3 |
| | | | | 201 | 9.54 | 71.7 | 69.9 |
| 26 | 30 | 3500 | 1.03 | 222 | 10.5 | 97.4 | 95 |
| | | | | 238 | 11.3 | 90.9 | 88.6 |

The results of the second series of tests illustrate the almost linear dependence of the amount of CO₂ produced as a function of treatment time. Thanks to the remarkable stability of the plasma obtained by the method according to the invention, longer treatment times may be extrapolated in order to obtain more complete decompositions of the pollutants.

Third series of tests—hexadecane

In the third series of tests - on hexadecane, 200 mg of hexadecane were subjected to a glow discharge for 5 minutes, with a current of 30 mA, in the presence of 2 ml of water, under a gas stream (containing 2% oxygen) flowing at a rate of 102 and 150 ml/min. The results are given in Table 5.

TABLE 5

| | Total | | | | | |
|---|---|---|---|---|---|---|
| | flow | | | | Degraded | |
| | rate | O₂ | | Charge | mass | Energy |
| Test | (ml/ | flow rate | Voltage | density | equivalent | density/kg |
| No. | min) | (ml/min) | (V) | (C/cm²) | (mg) | (kWh/cm² · kg) |
| 27 | 102 | 2 | 3500 | 0.234 | 0.962 | 236 |
| 28 | 150 | 2.94 | 3220 | 0.234 | 1.620 | 129 |

The results of the third series of tests illustrate the essential role played by oxygen in the method and the use according to the invention.

Fourth Series of Tests

In the fourth series of tests, 200 mg of hexachlorobenzene or hexadecane, in the presence of a defined quantity of water, were subjected to a glow discharge for 5 min. The proportion of oxygen was 5% and the flow rate was 150 ml/min. The current was 28 mA and 20 mA in the case of hexadecane and hexachlorobenzene, respectively. The results expressed as μmol of CO₂ produced are given in Table 6. They illustrate the benefit of carrying out the decomposition in the presence of water.

TABLE 6

| Test No. | Molecule | No water | 10 μl H₂O | 100 μl H₂O | 2 ml H₂O |
|---|---|---|---|---|---|
| 32 | HD | 84.8 | 99.9 | 111.8 | 120 |
| 33 | HCB_{z} | 42.6 | 52.6 | 100.2 | 46.7 |

1. A method of forming a plasma intended for the chemical treatment of substances, in which at least two electrodes and a layer of dielectric material located between the two electrodes are placed in a chamber in order to form plasma glow discharges, the method comprising introducing a controlled flow comprising oxygen into the chamber, the controlled flow during its introduction into the chamber containing none of the substances to be treated.

2. The method according to claim 1, wherein the electrodes are of concentric cylindrical geometry.

3. The method according to claim 1, wherein at least one of the electrodes is covered with a dielectric layer comprising alumina.

4. A method for decomposing toxic substances comprising treating the toxic substances with the plasma formed by the method of claim 1.

5. The method according to claim 4, wherein the toxic substances comprise organochlorines.

6. A method for decomposing toxic organochlorine substances in the liquid or solid state comprising treating the toxic organochlorine substances with the plasma formed by the method of claim 1.

7. The method according to claim 6 wherein the toxic substances are in the solid state.

8. The method according to claim 4, wherein the plasma includes water.

9. The method according to claim 4, wherein the CO₂ produced during decomposition of the toxic substances is measured.

10. A device for forming a plasma, comprising at least two electrodes located in a chamber, in order to form plasma glow discharges, and means for introducing a controlled flow of oxygen-containing gas into the chamber, wherein at least one of the electrodes is covered with a dielectric layer comprising alumina.
